(19) United States
(12) Patent Application Publication
(10) Pub. No.: US 2002/0111956 A1
(43) Pub. Date: Aug. 15, 2002

(54) Method and apparatus for self-management of content across multiple storage systems

(76) Inventors: Boon-Lock Yeo, Sunnyvale, CA (US); Kai Li, Priceton, NJ (US)

Correspondence Address: John P. Ward, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/955,550

(22) Filed: Sep. 17, 2001

Related U.S. Application Data
(60) Provisional application No. 60/233,159, filed on Sep. 18, 2000.

(51) Int. Cl. G06F 12/00

(52) U.S. Cl. 707/200

(57) ABSTRACT

A method and apparatus for creating a scalable storage system for convenient storage and retrieval of content through self-management of content is described. Storage systems can be easily added to a network. Within an individual storage system, a self-managing process monitors the changes in relevant file content and tracks the changes using a local database. All of the changes in the local database are further propagated to a global database to facilitate access and retrieval from any computers in the same network. Users accessing the content only need to focus on the content and do not have to worry about where the content is located. In addition, a sampled representation (or “reduced representation”) is created of the content to enhance the retrieval process.

The present application claims priority to the provisional filed application entitled Systems and Methods for Self-management of Content Across Multiple Storage Systems, filed on Sep. 18, 2000, serial No. 60/233,159, which is also incorporated herein by reference.

### FIELD OF THE INVENTION

The invention relates generally to systems and methods for self-management of content across multiple storage systems, and more specifically to creating a scalable storage system for cost-effective storage and retrieval of content.

### BACKGROUND OF THE INVENTION

Multimedia data, especially video data, takes up a lot of storage. For example, MPEG2 video at DVD resolutions easily requires 5 Gbytes of data for a full-length movie. Video captured using the 25 Mbits/sec DV format is typically used for editing purposes—a one-hour DV video occupies about 11 Gbytes of data. To store 100 hours of DV content thus requires over 1 Terabyte of storage capacity; to store 1000 hours requires over 10 Terabytes.

The cost of storage increases very quickly with larger and larger storage requirements. For instance, it is very expensive to purchase 5T storage solutions. On the other hand, it is much more economical to purchase ten ½ T storage solutions, for effectively the same storage capacity. There is a ten-fold difference in prices between the two setups. The problem, however, with the ten ½ T storage solutions is that the users have to remember or know on which of the storage systems a particular media content resides. This is especially tedious when there are more than one users adding content to the storage solutions.

There is thus a real need for a scalable storage solution that is based on building blocks of smaller storage systems and that offers intelligent software that eliminates the need of the user to know where content resides.

One popular application allows individuals to search for MP3 music on the Internet. A user first registers on the application's site and specifies a folder on his/her computer for sharing of MP3 music files. MP3 files on the shared folder will be searchable by others on the Internet using the search engine on the application's site. MP3 music will be downloaded from some user's computer, not from a central server. When MP3 music is downloaded onto a computer, the new location of the music will be registered at a central server and made available for future download. This distributed approach of data download potentially allows a user to retrieve a piece of MP3 music from some computer closer to him/her versus getting it from a central server. This popular application, however, does not allow a user to store data onto another user's computer. Furthermore, the application encumbers the user's computer by requiring him to install the application thereon. Moreover, the application does not provide a preview of the music to be downloaded, introducing frustration when the music downloaded does not match the description given.

Another popular application provides a similar data-sharing framework. The difference is that there is no central server; rather, a search query is relayed from one computer on the application's network to another until a match is found or when all computers are searched. However, this application suffers from the same limitations of the application discussed above.

There are also in existence some operating systems which permit a user to access files distributed over multiple computers in a transparent manner; that is, the user may manipulate the files without knowledge or care of which computer stores the files to be manipulated. The files appear to the user to be stored at one central location. The primary drawback of such operating systems is that the same operating system must be installed on all computers participating in the file-sharing scheme, encumbering each computer and restricting the user's choice of operating system. Furthermore, as with the applications discussed above, these operating systems fail to provide a preview of the files to be accessed.

### SUMMARY OF THE INVENTION

A method and apparatus for scalable storage systems that provide self-management of multimedia content are described. Each storage system is individually used to hold a large collection of multimedia content, including video, images, audio and graphics. When placed in a network, each storage system and the content within each system are made available to other storage system and computers on the network—one can read, update and modify the content on any storage system from other storage systems or computers on the network. In addition, indices are automatically generated within each storage system to facilitate easier access and retrieval. The indices are further propagated to the network and made available to all other storage systems. A global index is maintained either by all storage systems or a central server. To someone trying to access content, the global index provides a global view of the location and information regarding each piece of content in a transparent manner.

This system scales with the number of storage systems. One can conveniently add more storage systems to the network if more storage is needed. From the retrieval standpoint, the global index offers a unified view of content across all the systems, regardless of how many storage systems are in the network or where each piece of content is located.

This solution offers to the users a global view of all the content in all the storage systems. Users only need to focus on content, and not location, when they work. Through self-management of the content within each storage system and through the maintenance of a global index, this invention provides a solution that offers scalable cost-effective storage and convenient retrieval of the content.

### BRIEF DESCRIPTION OF THE DRAWINGS

FIG. 1 shows a network of self-managing storage systems, user computers and global index server according to one embodiment;

FIG. 2 shows a view of a user computer's file system in which two storage systems are mounted on the computer according to one embodiment;

FIG. 3 shows the flow of events and information in the self-management software according to one embodiment;

FIG. 4 shows the sequence of events during an OS triggered file change event according to one embodiment;

FIG. 5 shows the steps of processing the FileChange Queue according to one embodiment;

FIG. 6 shows the steps of the FileChange Processor processing new and updated files according to one embodiment;

FIG. 7 shows the detection of deletion and removal of deleted files from LocalIndex according to one embodiment;

FIG. 8 shows one page of a visual browsing interface according to one embodiment; and

FIG. 9 shows a more detailed view of a video loc2_{—}121.mpg according to one embodiment.

### DETAILED DESCRIPTION

A method and apparatus for scalable storage systems that provide self-management of multimedia content are described. Multimedia content may include, in one embodiment, many different data types, such as seismic data, satellite images, medical images, document images, genomic and proteomic data, scientific data, etc. In the following description, for purposes of explanation, numerous specific details are set forth in order to provide a thorough understanding of the present invention. It will be evident, however, to one skilled in the art that the present invention may be practiced without these specific details.

### NETWORK OF SCALABLE SELF-MANAGING STORAGE SYSTEMS

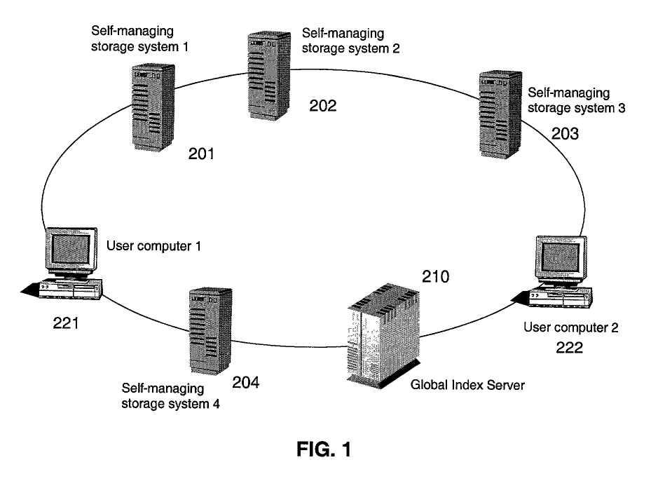

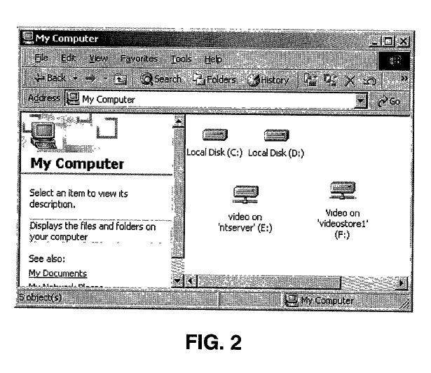

FIG. 1 shows a network of scalable self-managing storage systems according to one embodiment, together with several user computers and a Global Index Server used to maintain the global index. The user computers are where the users perform typical work or computation on. Storage on each of the storage systems is made available to other systems on the network through standard file sharing methods. For example, each storage system may be mounted as a network drive on a popular operating system. FIG. 2 shows a screenshot of an example of a typical user computer file system according to one embodiment, in which two remote storage systems (named ntserver and videostore1) have been mounted on the current computer. Users can access the content within each of the storage systems—they can add, delete or modify the content. To someone trying to access content, the global index provides a global view of the location and information regarding each piece of content in a transparent manner.

A local index, called the LocalIndex, is maintained within each storage system to track the change and location of each piece of content. In one embodiment, the LocalIndex would consist of the following set of information: (1) file id, (2) name of file, (3) extension of file, (4) directory location, and (5) date and time of last modification. A relational database can be used to represent the LocalIndex—in this case, the schema of the relational database will consist of a table with the above set of information. The index may further consist of a sampled representation of the original content (or “reduced representation”). For example, a video can be represented by a few frames, an audio clip represented by the first 5 seconds of the clip, etc. An example of sampled representation of video is that of using a frame to represent a shot. An example implementation of using frames to represent a video can be found in “Rapid Scene Analysis on Compressed Video”, B. L. Yeo and B. Liu, IEEE Transactions on Circuits and Systems for Video Technology, Vol. 5, No. 6, pp. 533-544, 1995. Such representations enhance the access and retrieval process.

Other examples of sampled representation for other data types include:

seismic data: sampled 2D images of the 3D seismic data;

satellite images: thumbnail images;

3D medical images: x-ray projections;

document images: OCR texts for text search;

speech data: text created using speech-to-text conversion tools; and

genomics/proteomics data: signatures of structure.

The local indices on all the storage system are further propagated to the network. In FIG. 1, all the local indices are maintained centrally by the Global Index Server 210. Access and retrieval of content are made through the Global Index Server 210. It provides a content-centric view of all the content in the storage systems on the network. The Global Index Server 210 will use a relational database to track the change and location of each piece of content on all the storage system. In one embodiment, the following information, called the GlobalIndex, will be maintained: (1) name of file, (2) extension of file, (3) name of storage system, (4) directory location, and, (5) date and time of the last modification. Note, in one embodiment, the Global Index Server 210 tracks one more piece of information, i.e., the name of storage system, compared to the local indices maintained by each of the storage system.

Using the Global Index Server 210, users are no longer required to look at the individual storage system to get access to the required content. The Global Index Server achieves transparent access to the content. As more storage systems are added to the network, the amount of storage available to the users grows. At the same time, the retrieval process remains the same, thereby achieving scalability in storage without increase in retrieval complexity.

### SELF MANAGEMENT ON STORAGE SYSTEMS

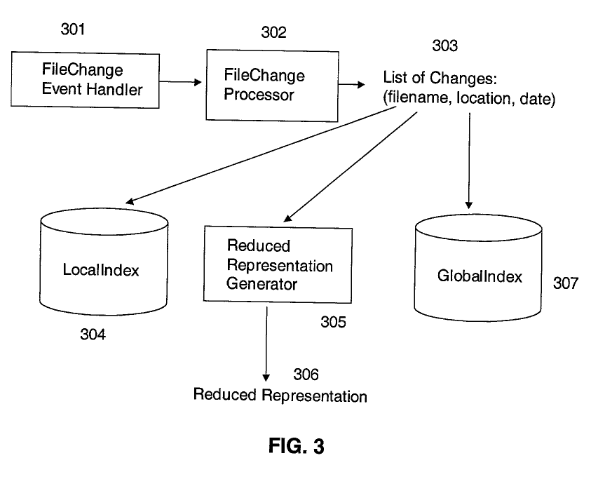

In one embodiment, within each storage system, self-management software constantly monitors the changes to the content and updates a local index to track the changes. In one embodiment, the self-management software is present only with each storage system, so no specialized software needs to be present on a computer accessing the content. One embodiment of the self-management software consists of several components shown in FIG. 3: (1) a FileChange Event Handler 301 that tracks the changes in file status, i.e., any addition, deletion or updates to any files, (2) a FileChange Processor 302 that updates the LocalIndex 304, a local database maintained at the storage system, based on the changes, and (3) a Sampled Representation Generator 305 (or “Reduced Representation Generator”) that creates sampled representations (or “reduced representations”) of the media content. The outcome of the FileChange Processor 302 is a list of changes for each changed files; the information includes the filenames, the file location and the date/time of the last change. This list of changes is reflected in the local database LocalIndex 304. In addition, the same list of changes is propagated to the GlobalIndex 307, a global database maintained in a Global Index Server 210.

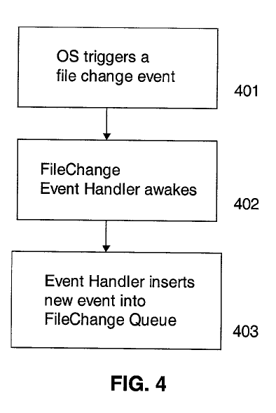

The FileChange Event Handler 301 is actually an event handler that will be triggered by the operating system in the event that a file has been changed. For example, in one popular operating system, the function “FindFirstChangeNotification( )” creates a change notification handle in the event that some changes to a file have been made in a specified directory. Specifically, the chain of events according to one embodiment is illustrated in FIG. 4. In step 401, the operating system triggers a file change event, i.e., changes have been made to some files in a specified directory. In step 402, the FileChange Event Handler awakes; it then inserts a new event into a FileChange Queue at step 403. The FileChange Queue is a queue that captures a file change event together with the date and time of the event.

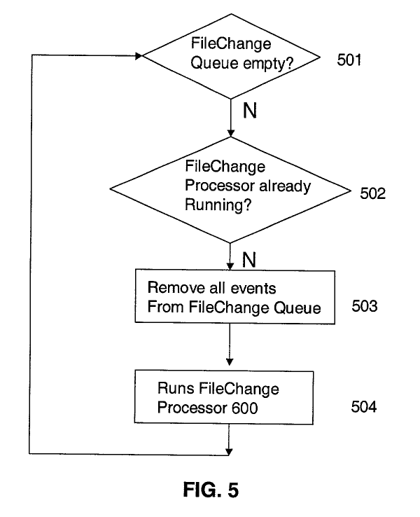

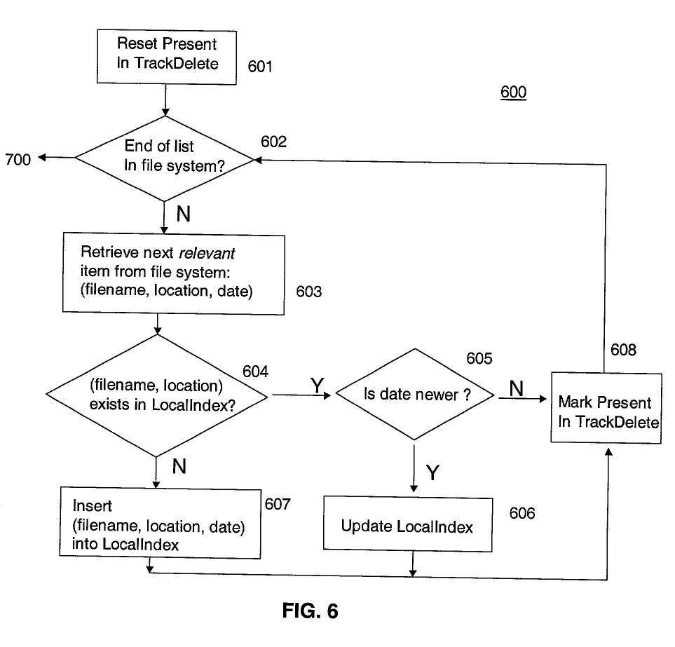

To process the events inserted by step 403 into the FileChange Queue, the FileChange Event Handler 301 in one embodiment invokes FileChange Queue Monitor. Alternatively, the FileChange Queue Monitor in another embodiment can run by itself periodically; for example, every 5 minutes. The steps taken by the FileChange Queue Monitor in one embodiment are illustrated in FIG. 5. First it checks in step 501 if the FileChange Queue is empty; if the queue is empty, there is no file change event and nothing needs to be done. If the queue is not empty, it needs to further check in step 502 that the FileChange Processor 600 shown in FIG. 6 according to one embodiment is not already running. The FileChange Processor 600 tracks the changes (addition, deletion and update) made to the files and updates the databases accordingly. If the FileChange Processor is not currently running, then in step 503, all events are removed from the FileChange Queue and the FileChange Processor 600 is invoked in step 504. The removal of events ensures that there is no need to run FileChange Processor again if no new events are added when the FileChange Processor is running.

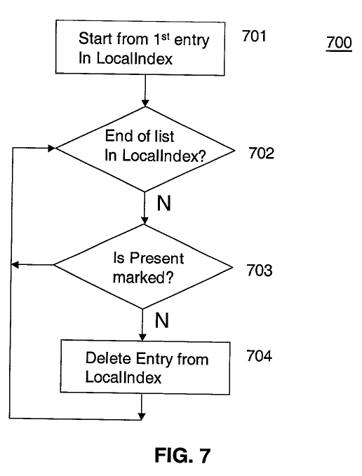

In step 601, the FileChange Processor 600 (shown in FIG. 6 according to one embodiment) first resets all the entries in a column called Present in the special table called TrackDelete. This table consists of two columns: FileID that corresponds to the file id in the LocalIndex and Present. The purpose of this table is to track all files that have been removed. As all the relevant media files are being visited, the corresponding Present column will be marked. At the end of the processing, entries in both the LocalIndex and TrackDelete tables that have not been marked will be deleted in process 700 shown according to one embodiment in FIG. 7. In step 602, the next file in the file system will be examined; if there are no more files to be examined, then process 700 is invoked to remove all entries in LocalIndex corresponding to deleted media files. Otherwise, the next relevant file is examined in step 603. In one embodiment, relevancy is based on the type of media files that the storage system is set up to manage. For example, if the storage system is set up to manage video files, then all files with extension MPG, AVI and MOV will be relevant. At this step, the filename, file location and date and time will be retrieved. Next, in step 604, the filename and location will be compared against the LocalIndex database. If there exists an entry with an identical filename and location, then the change, if any, will be in the form of an update. In this case, at step 605, the date and time is compared against the corresponding date and time entry in the LocalIndex database. If the date and time is newer, then LocalIndex is updated with the new date and time in step 606. If, at step 604, there are no entries in LocalIndex with identical filenames and locations, then the file is new and has not been tracked in LocalIndex. In this case, information about this file (i.e., filename, location and date and time) is inserted into the LocalIndex database at step 607. The corresponding Present column in TrackDelete is marked in step 608 to indicate that this file is present. The process then revisits step 602 to retrieve the next file in the file system.

Process 700 (shown in FIG. 7 according to one embodiment) iterates through all the entries in the LocalIndex and deletes all entries with the corresponding Present column in TrackDelete that have not been marked. This process handles the case of file deletion from the file system. In one embodiment, processes 600 and 700 produce a list of changes 303 in FIG. 3. The changes include new files added, files modified and files deleted. This list of changes will be propagated to the GlobalIndex on the network. In one embodiment, the list of changes will be sent in command form with data in the following formats:

| | |
|---|---|
| Addition: | [insert] medianame pathname date/time storagename |
| Update: | [update] medianame pathname date/time storagename |
| Delete: | [delete] medianame pathname storagename |

The first part of the command is the instructions. There are three possibilities: insertion, update or deletion. The second part is the name of the content file. The third part is the directory path. The rest of the information is the date and time of the last update and the name of the storage system.

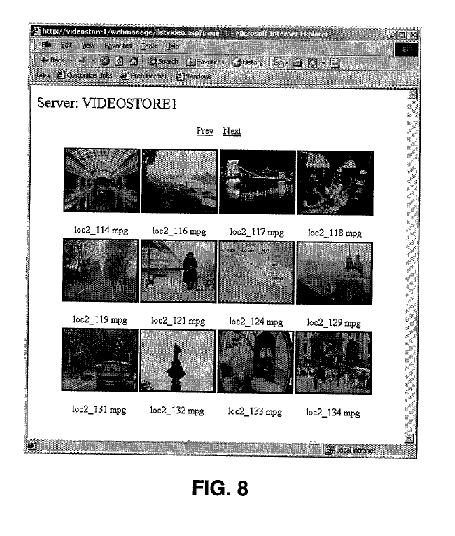

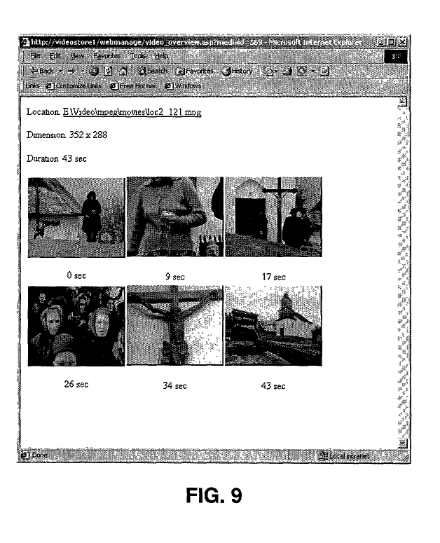

In addition, this list of changes is used by the Sampled Representation Generator 305 (or “Reduced Representation Generator”) in FIG. 3, according to one embodiment, to generate a new set of sampled representations. For video, a Summary Generator is used in one embodiment to create a few still summary images that visually represent the video. The reader is referred to “Rapid Scene Analysis on Compressed Video”, B. L. Yeo and B. Liu, IEEE Transactions on Circuits and Systems for Video Technology, Vol. 5, No. 6, pp. 533-544, 1995 for a possible Summary Generator. To further facilitate retrieval using browsing techniques, the first still summary image can be picked and all or some of such images for the video collections can be shown on a page for quick browsing. FIG. 8 shows a page, according to one embodiment, from the visual browsing interface for storage of video content. A still summary image is used to represent each video. On this page, a user can get a quick overview of 12 video clips at the same time. Furthermore, the user can step to the next or previous page to look at other video clips. A user can also click on a particular image to get a more detailed view of the video clip and also to retrieve the video. FIG. 9 shows an example screen shot, according to one embodiment, of the detailed view that consists of 6 summary images. In addition, it also contains a link to the actual video for viewing. The Global Index Server 210 of FIG. 2 serves the visual browsing interface in one embodiment. However, the still summary images and the actual media content still reside on the storage systems. Thus, transparency of the physical location of the content is achieved through the visual browsing interface.

The approach of self-management described in this invention allows automatic tracking of changes, while maintaining the use of standard file system interface. This means that user does not have to worry about explicitly logging the changes through some special software. Users only need to focus on working on the content as opposed to focusing on location. The location of the content is transparent to a computer accessing the content. The system also allows easy scaling of the storage systems to support increasing demand for storage. This in turn offers a scalable cost-effective method to deal with the need of increasing storage demands in multimedia computing applications.

### EXTENSIONS

The above methods and systems for scalable storage systems that provide self-management of multimedia content can be extended in several ways, described below according to different embodiments:

1. User directories and permissions can be imposed on the storage systems. A user can only see the media content which he/she has permissions to.

2. It is possible to make one or more storage systems also take on the role of global index server, i.e., maintain all the indices of the storage systems. This provides fault tolerance. Thus, if the central global index server fails, the global index will still be available. On one extreme, all storage system can host the global index.

3. The visual browsing interface can be extended to allow users to add textual annotations to the individual media content. Text search can then be performed on the textual annotations.

4. The systems and methods of self-management on storage servers and propagating changes to a global index server or other storage servers can be extended to user computers as well. In this case, the user computers would allocate part of the storage for resource and file sharing. Self-management as described below runs on the special part of the storage.

5. Media content can be replicated to other storage systems using the self-management software. The software would copy media content during inactive time of the day (e.g., midnight to 4 am) to other storage systems. The locations of the additional copies will be logged at the local and global indices. This mechanism provides a seamless way to backup media content. It also potentially brings the content closer to the end-users—this is especially useful in a intranet environment where there are multiple offices at different geographical locations.

6. The self-management software can provide additional management capabilities such as automatic transcoding (i.e., convert a media into another format, e.g., convert AVI source video formats into ASF for internet streaming).

The method and apparatus disclosed herein may be integrated into advanced Internet- or network-based knowledge systems as related to information retrieval, information extraction, and question and answer systems. One embodiment of a computer system has a processor coupled to a bus. Also coupled to the bus is a memory which may contain instructions. Additional components coupled to the bus are a storage device (such as a hard drive, floppy drive, CD-ROM, DVD-ROM, etc.), an input device (such as a keyboard, mouse, light pen, bar code reader, scanner, microphone, joystick, etc.), and an output device (such as a printer, monitor, speakers, etc.). Of course, an exemplary computer system could have more components than these or a subset of the components listed.

The method described above can be stored in the memory of a computer system (e.g., set top box, video recorders, etc.) as a set of instructions to be executed. In addition, the instructions to perform the method described above could alternatively be stored on other forms of machine-readable media, including magnetic and optical disks. For example, the method of the present invention could be stored on machine-readable media, such as magnetic disks or optical disks, which are accessible via a disk drive (or computer-readable medium drive). Further, the instructions can be downloaded into a computing device over a data network in a form of compiled and linked version.

Alternatively, the logic to perform the methods as discussed above could be implemented in additional computer and/or machine readable media, such as discrete hardware components as large-scale integrated circuits (LSI's), application-specific integrated circuits (ASIC's), firmware such as electrically erasable programmable read-only memory (EEPROM's); and electrical, optical, acoustical and other forms of propagated signals (e.g., carrier waves, infrared signals, digital signals, etc.); etc.

Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

What is claimed is:

1. A method comprising:
generating on one of a plurality of separate storage systems a sampled representation of content stored on the separate storage systems; and
providing access to the sampled representation on the first separate storage system, wherein an identity of the first separate storage system is transparent to a computer accessing the sampled representation.

2. The method of claim 1, wherein generating occurs when the content is stored or modified.

3. The method of claim 1, wherein means providing for transparency are present only on the storage system.

4. The method of claim 1, wherein accessing includes accessing from a computer other than one of the plurality of storage systems.

5. The method of claim 1, further comprising storing the sampled representation on the separate storage system.

6. The method of claim 1, wherein content includes audio content and the sampled representation includes a sampled representation of audio content.

7. The method of claim 1, wherein content includes multi-frame video content and the sampled representation includes a sampled representation of multi-frame video content.

8. The method of claim 1, wherein transparency is achieved through a global index server.

9. The method of claim 1, wherein transparency is achieved through a visual browsing interface.

10. An apparatus comprising:
a plurality of separate storage systems to generate a sampled representation of content stored on the separate storage systems; and
a plurality of computers coupled to the separate storage systems, the computers to provide access to the sampled representation on the first separate storage system, wherein the identities of the separate storage systems are transparent to a computer accessing the sampled representation.

11. The apparatus of claim 10, wherein the storage systems are to generate a sampled representation when the content is stored or modified.

12. The apparatus of claim 10, wherein means providing for transparency are present only on the separate storage systems.

13. The apparatus of claim 10, wherein the separate storage systems are to store the sampled representation.

14. The apparatus of claim 10, wherein content includes audio content and the sampled representation includes a sampled representation of audio content.

15. The apparatus of claim 10, wherein content includes multi-frame video content and the sampled representation includes a sampled representation of multi-frame video content.

16. The apparatus of claim 10, wherein transparency is achieved through a global index server.

17. The apparatus of claim 10, wherein transparency is achieved through a visual browsing interface.

18. A machine-readable medium that provides instructions, which when executed by a plurality of machines, cause the machines to perform operations comprising:
generating on one of a plurality of separate storage systems a sampled representation of content stored on the separate storage system; and
providing access to the sampled representation on the first separate storage system, wherein an identity of the first separate storage system is transparent to a computer accessing the sampled representation.

19. The machine-readable medium of claim 18, wherein generating occurs when the content is stored or modified.

20. The machine-readable medium of claim 18, wherein means providing for transparency are present only on the separate storage systems.

21. The machine-readable medium of claim 18, wherein accessing includes accessing from a computer other than one of the plurality of separate storage systems.

22. The machine-readable medium of claim 18, wherein operations further comprise storing the sampled representation on the separate storage system.

23. The machine-readable medium of claim 18, wherein content includes audio content and the sampled representation includes a sampled representation of audio content.

24. The machine-readable medium of claim 18, wherein content includes multi-frame video content and the sampled representation includes a sampled representation of multi-frame video content.

25. The machine-readable medium of claim 18, wherein transparency is achieved through a global index server.

26. The machine-readable medium of claim 18, wherein transparency is achieved through a visual browsing interface.
